(19) United States
(12) Patent Application Publication
(10) Pub. No.: US 2006/0047515 A1
(43) Pub. Date: Mar. 2, 2006

(54) Analyzing human movement patterns

(76) Inventor: Brenda Connors, Truro, MA (US)

Correspondence Address: OFFICE OF NAVAL RESEARCH, OFFICE OF COUNSEL, 800 NORTH QUINCY STREET, ARLINGTON, VA, 22217-5660, US

(21) Appl. No.: 11/210,731

(22) Filed: Aug. 25, 2005

Related U.S. Application Data
(60) Provisional application No. 60/603,990, filed on Aug. 25, 2004.

(51) Int. Cl. G10L 21/00

(52) U.S. Cl. 704/270

(57) ABSTRACT

Movement analysis is expanded to assist not just in determining the emotional, cognitive, and performance processes of subjects, but to also predict and explain a subject's actions. The analysis is particularly applicable to leaders, but may be applied to other subjects. Additionally, non-expert practitioners may more readily benefit from analyzing a subject's movements.

### CROSS-REFERENCE TO RELATED APPLICATIONS

This application claims the benefit of the Aug. 25, 2004 filing date of the provisional application entitled “ANALYZING HUMAN MOVEMENT PATTERNS IN SOCIAL AND/OR POLITICAL CONTEXTS,” invented by Brenda L. Connors, Ser. No. 60/603,990, the entirety of which has been incorporated herein by reference.

### STATEMENT REGARDING FEDERALLY SPONSORED RESEARCH OR DEVELOPMENT

(Not Applicable)

### INCORPORATION-BY-REFERENCE OF MATERIAL SUBMITTED ON A (COMPACT DISC

(Not Applicable)

### BACKGROUND OF THE INVENTION

(1) Field of the Invention

The present invention relates generally to determining the intent and more specifically to determining the behavioral movement patterns (cognition, emotion, performance) of a speaker, particularly where that speaker is a leader.

(2) Description of Related Art Including Information Disclosed Under 37 CFR 1.97 and 1.98

It has been widely recognized a person's thoughts and emotions and their movements are inseparable. Body movements and facial expressions and have been analyzed, for example, with a view to appreciating, in relation to baseline and context, a leader's communication and performance style behaviorally: committed, rhetorical, angry, sad, telling the truth, and dissimulating¹, and/or in relation behaviorally to topic. The investigation process has ranged, at the first level of inference, from macro to highly detailed micro analysis of movement.
¹Brenda Connors & Martha Davis, Nonverbal Communication Demonstration Project: Application of Movement Analysis to International Relations, Final Report, 1997. Brenda Connors & Martha Davis, Microanalytic Profiling of Foreign Leaders, 1999, Unpublished US Government reports, 1999, contracts MDA-908-97-M 7238 and MDA-908-98-C0006.

A great deal of attention has been paid to analyzing the movements of world political leaders. Clearly, any information gained regarding how a particular leader thinks, acts, and perceives can assist in negotiating and setting policy.

Due to the complexity of analyzing and interpreting human expression, even research at times has mistakenly assumed certain movements might have universal meaning. For example, some have mistakenly associated a sideways glance of the eyes in a certain direction while speaking as an indication of lying. Often, however, such impressionistic analyses ignore the unique physical condition and patterning of the speaker as well as the individual and cultural differences that can affect body movement.

More sophisticated analytical approaches² search within patterned style for how uniquely an individual's differences emerge. These patterns will be compared over a period of time and in relation to specific events. Based on this more sophisticated approach, a movement analysis expert can reasonably estimate the demeanor of the speaker (e.g., committed, conflicted, obfuscating, etc.). The movement analyst may also consult with medical experts to determine whether certain movement patterns suggest injury, infirmity, or illness. Although these methods provide clues to a speaker/leader's demeanor (cognitive, emotional and performance), these methods have not analyzed body movements to gain insight how the speaker/leader ultimately takes action.
²Martha Davis, Guide to Movement Analysis Methods, New York State Psychiatric Institute, 1991. David McNeill, Hand and Mind: What Gestures Reveal About Thought: University of Chicago Press, 1992.

Some impressionistic attention among the media for example has been paid to analyzing the movements of world and political leaders. However, while our hard wired sensors inform on a basic level because of the multidimensional aspect of human signals and the difficultly in reading movement and emotion for example, more expert knowledge and interpretation is required for an accurate assessment. Clearly, reliable information gained regarding how a particular leader thinks, acts, perceives and performs can assist in negotiating and setting policy. Unfortunately, some of the prime beneficiaries of movement analysis (diplomats, strategic analysts, and foreign policy experts, for example) have neither the time nor the resources to obtain the required expertise.

### BRIEF SUMMARY OF THE INVENTION

It is an object of the present invention to analyze audiovisual source material of a speaker to determine how that speaker takes action.

In another embodiment of the present invention, a non-expert practitioner may be trained, relatively quickly, to use movement analysis to gain insight into a speaker/leaders behavior.

These and other objectives are achieved by first selecting audiovisual material in which the speaker is visible, speaking, and audible. Where the analyst (such as a political analyst) is not an expert in movement analysis, it is preferable to know the context surrounding the audiovisual source material and the relationship between said context and the speaker. Where the analyst is an expert in movement analysis, such knowledge is unnecessary, and, in some cases, may bias the analysis.

The audiovisual material is first reviewed without audio in order to establish the baseline of the speaker's most primary movement pattern. This baseline pattern (and, at times how it further relates to other patterns that emerge) is detected. Then a correspondence between specific movements and the speaker's behavioral state is hypothesized as movement is a reflection of inner attitude and state of body and mind. Then, additional source material in which the same speaker is visible (and, for non-expert analysts, the context surrounding the additional source material and the relationship between the context and the speaker are preferably known) is further reviewed for a recurrence of the previously noted behavior patterns and standard expressions. When it is determined that these expressions are consistent over time and context they become known as having a relationship to the speaker's performance: emotional and cognitive state. Finally, the pattern and certain qualitative elements that inform the phrasing (exactly how they do what they do) of the speaker's movement are examined and correlated with the speaker's approach to accomplishing an objective, that is, in taking action.

### BRIEF DESCRIPTION OF THE DRAWINGS

FIG. 1 is a photograph of Boris Yeltsin showing a disunified expression.

FIG. 2 is a photograph showing one of Jiang Zemin's expression.

FIG. 3 is a photograph showing another of Jiang Zemin's happy expression.

FIG. 4 is a photograph showing yet another of Jiang Zemin's obfuscating expression.

FIG. 5 is a photograph showing Saddam Hussein's disunification between torso and arm.

FIG. 6 is a photograph of Col. Muarnmar Al Qadhafi in highest conviction.

FIG. 7 is a photograph of the late Syrian President Hafez Assad gesturing and simultaneously revealing stress.

FIG. 8 is a photograph of Adolph Hitler showing his intrinsic body attitude of inward energetic twisting³
³M.Davis & D. Dulcai, “Hitler's Movement Signature.” TDR:Journal of Performance Studies 36 (1992), 152-172.

### DETAILED DESCRIPTION OF THE PREFERRED EMBODIMENTS

The present invention examines the behavior patterns of a leader and searches for how isomorphically they become reflected in their actions in political military context. “Isomorphic” refers to things having the same structure but in a different manifestation. In regard to movement patterns and their recurring nature, how the structure and quality of pattern crystallize, from the smallest identifiable expressions, such as impulses of sensation, to larger, full-body action on the world stage, is our concern. Before isomorphic patterns in a leader's body movement can be detected, however, the subject's base level patterns and style must be determined.

The identity of a person is patterned in the body. The pattern is like a biography: laid down early and, absent brain damage, unchanging over a lifetime. All experience gets woven into the body in a regular order or structure. The body—its sensing, feeling, thinking, and speaking—expresses the person as in a moving picture. A practitioner who becomes attuned to reading body movement observes the subject/leader nonverbally “telling” his or her story.

When a subject first becomes known (for example, when a leader emerges), the questions initially arise as to what kind of analysis best suits his style, what speaks most loudly, and what kind of analysis might uncover those patterns most efficiently and richly. For example, Muammar Qadhafi's gesture system was microanalyzed, not his facial expression, because his gestures are the most integrated and expressive aspect of his style. Knowledge of what venues and potentially what subsystems a leader relies upon is useful in briefing a movement expert and in designing an inquiry that more directly targets points of interest.

Knowledge of what venues and potentially what nonverbal communication subsystems a leader relies upon is useful in briefing a movement expert and in designing an inquiry that more directly targets points of behavioral and substantive interest. Psychologists, anthropologists, psychiatrists, and other behavioral scientists focus on different aspects of patterning to glean ways in which a person organizes himself. Movement underpins all behavior, and movement analysis is one inroad that has common links to all these perspectives and can afford insight and a common language into pattern or style.

Experts at movement analysis can very quickly tell “what's up” with a given subject/leader or interaction. For example, when an influential but little known political leader comes on the world stage, a comprehensive movement/behavioral style analysis can offer insight into patterns of his or her lifelong communicative style:
Cognitive decision-making style (short- and long-term) and how he or she may interpret events or plan responses
Psychological conflict indicating confusion or incoherence as well as strength and modes of recovery, moods and what they look like in expression; what topics are problematic, when a subject becomes intractable or yielding to pressure or persuasion
Stress signals
Levels of certitude on a topic
Medical condition and evidence of chemical influences
How the body reflects credibility, evasion, obfuscation, and dissimulation
Relationships with other high-level officials, subordinates, and potential successors
Patterns of dominance and affiliation.

A preliminary assessment of about five to ten hours can initially inform movement experts which nonverbal directions to explore more deeply and suggest what other traditional methods, such as transcript analysis, could be integrated for a most comprehensive portrait. Once primary patterns have been detected, they can be tracked over time and context.

Movement analysis is both macro and micro. First, scanning involves a look at the big picture and the general integration and coordination of the whole body posture and parts (posture, gesture, facial expression, head and neck, eye gaze) as well as the general level of and quality of energy flow and tension. Performance is also key in distinguishing authentic hardwired pattern from the put-on flourish. There are aspects of performance detectable through movement that underpin a leader's style. Tracking these aspects of behavioral style offers clues to authentic versus feigned expression. Here is where appreciating movement analysis at a microanalytic level is critical. General movement organization tells the expert eye basically that something's up and maybe out of sync. Microanalysis can tell us more precisely just how, where, and why the interruptions emerge in a body system, especially when nonverbal analysis is done in correlation with speech. It can also tell us about a leader's overall strategy and how he or she may perceive the means to achieving his goals. For example, Yeltsin's cognitive style, analyzed though his gesture quality and structure of patterning, revealed that his decision making was goal driven, but he pays little attention to the means to get there.

Pattern Detection: Pattern detection is a way of uncovering what behavioral structures underpin a person's style or baseline. Imagine an onion with many layers as style. First, look for the most elemental aspects in movement behavior, the low baseline of how someone goes about the simple tasks in life: buying coffee in the morning, walking to work, or sitting down to an interview. Style is also about personal best, and the pattern that underlies peak performance, a leader's finest communicative moments. Baseline style is that grid or setting that the system holds in reserve but can access all the time. It's like the thermostat that has a consistent setting but can go either up or down depending on the climate. Detecting pattern also involves identifying a person's stress signs, their repertoire of expression that serves to balance the energy in the body as it strives to cope with the varying tension of day-to-day affairs.

Baseline style is composed of: The universal—what gets passed down through evolution, and, the individual—the scaffolding of what gets stamped through our families, our culture, and social factors such as gender, class, social convention, region, etc. All in all, style is a wholeness of individual pattern, the consistent stamp or signature of the individual. It is the hardwired DNA of your communicative expression. It is composed of both “quantity,” the mass of self (the posture, body parts, the subsystems) and “quality,” the glue or dynamic energetic organization of weight and flow that integrates it all together in expression.

Initially, movement analysis is done without benefit of sound. First, the observer takes in the whole of the body movement many times. The person being studied “reveals to the observer in movement” what's going on. After several viewings, the observer gains insight into what the subject relies on, in the body, for expression. Observing that reliance is part of style detection. Next, having determined what body subsystems are important, the observer reviews those areas closely and views the subject repeatedly for the smallest movement distinctions within that system. Here, the observer describes movement at the lowest level of inference or interpretation. That inventory offers the primary foundation for style.

If a behavior is not consistent, but is instead judged to be variable, another level of analysis may begin. This second phase of pattern detection informs the observerjust how many variations there are in a subsystem. Then, the next task becomes pinpointing the more nuanced variations of when and where these behavioral patterns emerge and coalesce. Here, computerized event recording is helpful. Technology, such as The Observer, the Noldus Information Technology Systems' software program allows the analysts' observations to be recorded and measured for reliability and for patterns to be graphically displayed.

Next, a check is done to see if these distinctions or behaviors—for example, in the head and neck or in gesture—are consistently displayed in varying contexts and over time. Moreover, looking at the comprehensive data as a whole offers insight into the big picture: it tells the analyst, in addition to the primary pattern, what else is going on in the person's larger system. The subject and his or her body are the analyst's best analytic resource. From detecting overall patterning, personas of thinking, feeling and performance that typically coalesce, will begin to emerge. The analyst's sensing body and eye will see this.

Once these patterns (with the sound off) are detected, another level of analysis begins. This involves correlating movement with the spoken word. More insights emerge from this level. The movements, for example, are now assessed against what exactly was being said at the time. For example, disruption or disorganization of speech-motion unity emerges at this level.

Detecting just where there is synchronization of speech and motion, moments of high performance and/or where that unity breaks down is part of the analysis. Correlating the verbal with the nonverbal informs us where a leader is smooth and where he is in trouble. Analysts can then confer with practitioners in regard to these behavioral findings to further delineate the inquiry and conduct comparative analysis of both movement and speech over other times and contexts. The specific degrees of certitude in relation to a topic are revealed and confirmed in this way.

For example, observing candidate Yeltsin in his 1989 interview with Jim Lehrer, an exchange of one question and answer in particular about the possibility of a “bloody armed revolution” evoked an extraordinary amount of disruption in his face. It was like a buckshot of impulses each firing in its own direction (See the FIG. 1 photograph.) This is a good example of a disunified expression and an example of how expression correlates with context uniquely and can be highly informative.

His face is signaling a high degree of conflict and stress. Observing Yeltsin's expressions on videotape over the course of the 26 questions/answers in the interview, the observer takes note because this display is so distinct from all his other expressions. The carefull analyst will dig further.

For example, an analyst may ask: What topic evoked this response? Were there any other such displays during the interview? Lehrer's questioning had to do with whether Yeltsin believed perestroika was moving too slowly, and whether an armed revolution was imminent. Just as the disruption of facial expression body movement emerged, Yeltsin responded, “yes,” saying that armed revolution might be necessary, although he would prefer it to be peaceful. This intense expression was not identified in any other interview, nor was it ever again seen in over 15 years of reviewed footage.

Yeltsin's expression in response to Lehrer's question foreshadowed his reaction to future events in the Soviet Union. Displays of such severe conflict in demeanor identified early on in a presidency can potentially give practitioners and analysts a foreshadowing as to where a leader may encounter trouble. Armed revolution did continue in the former Soviet Union, and in order to keep “reform” on track during his tenure, Yeltsin continued to suppress former Soviets in various stages of armed revolution. In view of this extreme nonverbal conflict related to the topic back in 1989, arguably it is not so surprising that the onset of Yeltsin's major health deterioration began as the bloody events in Chechnya first unfolded.

Specific insights related to a leader's movement, cognitive and emotional style, and isomorphic patterning can be gleaned from videotaped coverage. Yeltsin's primary pattern resembles this: he moves directly, strongly, and quickly. This movement is expressed isomorphically throughout his body, especially in his gestures. This tendency toward strong, quick, and direct action recurrently revealed itself in how Yeltsin spikes a volleyball, swings a tennis racket, shakes hands, or jumps out of a limousine. Recall that is the quality Yeltsin showed when mounting the tank (with quick, direct, strong determination) during the revolution. That is also how Yeltsin approached his favorite policy goal: U.S.-Russian relations. About this priority, he was goal directed, always assigning it first place while often sidestepping the means of sustaining it.

A leader's behavior (or anyone else's) arises mainly out of the impulses and inclinations felt in the body, and these cannot be adequately accounted for by an attachment to policy. While it may appear that policy exclusively determines a speaker's course of action, his or her day-today overall behavior (and its relation to policy) ultimately arises from his or her body/mind patterning. Of course, speakers, especially leaders, consider a strategic information base, but this base is filtered through their own familiar information base: the body's temperamental hardwiring. This patterning can be seen at several levels revealed through movement analysis and interpretation and through behavioral science, offering a basis for deeply appreciating their political actions. That is isomorphism. Detecting the recurrence of a patterned form in different manifestations is about recognizing a pattern and its layered expression from simple movement impulse to high-order complexity of thinking and action.

If subjects are repeatedly observed in video footage, detecting hardwired behavioral patterns about a topic visible through analysis of movement structure and quality can inform us about a leader's priorities: what he holds most dear, and what issues are merely instrumental or tactical.

Placing a leader's pattern in the overall political international context, however, is another complex matter. Doing so requires input from a myriad of perspectives, including the nature of the governmental system and a host of external factors. Additionally, those perspectives include such behavioral considerations measurable in movement in the body as the negotiation principles of Power, Information, Time, and Energy. Movement is the visible manifestation of our interaction with these elements and is a measurable dimension that offers the analyst another means of assessing the leader in relation to these universal forces.

The Laban Motion Factors relate to the physical aspects of movement. For example, an observer assesses quantitative aspects of the issue at hand: the physical distance one can go in the external environment; the force of gravity or strength the official brings to bear on the topic and the adversary; and the time duration or speed of the expected result. In terms of physics, these features are also seen as movement characteristics: how focus and movement paths relate to distance in space or the environment; how weight relates to force or pressure; and how duration relates to speed or time. Analysts also assess the degree to which an individual allows the ongoingness of energy or flow to proceed in the body, and the degree of flow that inspires their expression in any given moment.

Appreciating the factors of power and weight offers clues into how adaptable and stable a leader potentially is when under the gun. Movement analysts assess a leader's power by sensing his sheer physicality: its quantity but also how qualitatively (with strength or lightness) he moves it; where in space it moves, either with a direct pinpointedness or more of an indirect meandering, and finally, whether quick or sustained timing is revealed. Finally, one observes the freedom or boundedness of the energetic flow that activates the action and expression.

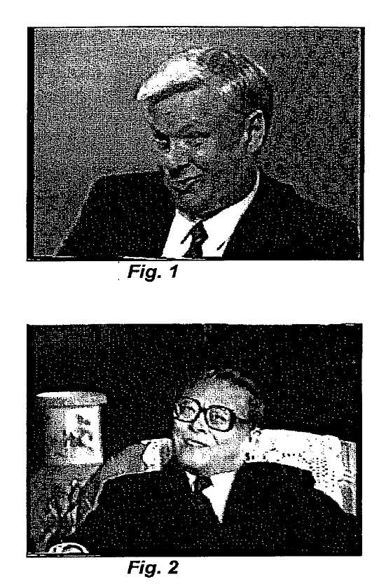

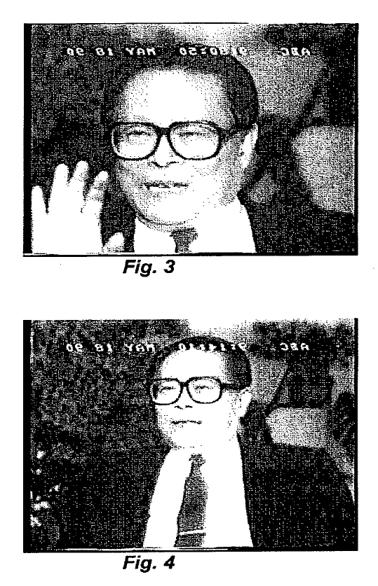

Flow is associated with life's energetic flux, the ongoingness that we can either constrain or allow to proceed. Rudolph Laban referred to flow as the alternation between the unconscious and conscious. Flow is a primary element from which you can begin to assess and acclimate to another person's style. For example, tracking Jiang Zemin's moods in response to various questions we can begin to appreciate how energetic flow serves to organize his expression:
Very Free Flow in his display of pleasure (FIG. 2)
Free Flow in his expansive persona seen in his gestures that become illustrative of his words (FIG. 3)
Bound Flow constraining movement in the trunk, shoulders, head, and absence of gesture in his rigid executive persona that restricts expression (FIG. 4)

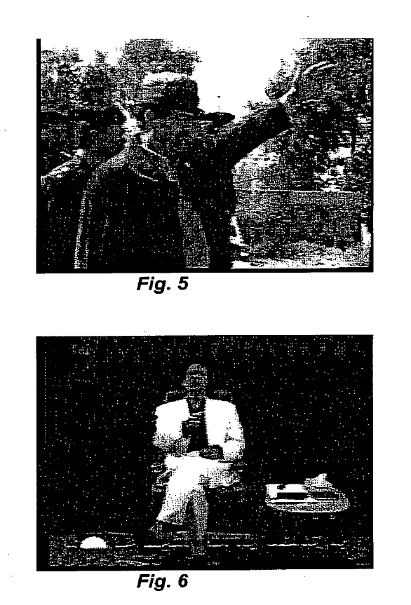

In assessing Saddam Hussein's flow and body pattern, the operative principle is control. Flow is constrained first on the physiological and cellular levels where tension permanently manifests in the muscles, bones, and body attitude. This is seen in his posture and body parts and reflected in the segmentation (separation) of his arm and shoulder from the torso (FIG. 5). Secondly, we see control in his thinking and that is reflected in his speech and gesture. Saddam's control becomes manifest in how each word he speaks is very precise and his pattern to correct his interpreters magnifies how his mind's hyper vigilance works.

Extensive efforts have been made to answer the question of how Saddam Hussein managed to remain in power during his last years. Movement analysis of his communicative patterns, with isomorphic analysis, sheds some perspective on the subject.

The theme of control always underlies Saddam Hussein's style. In April 1988, United Nation's report characterized Iraq's leadership as one that “systematically denies freedom of expression, thought and association with its citizens.” Saddam Hussein's movement isomorphically reflects that pattern of leadership. Control, even down to the cellular level, characterizes Saddam Hussein's movement and political behavior.

FIG. 6, an image of Col. Muammar Al Qadhafi, shows Qadhafi at what for him is his highest moment of nonverbal conviction, when the pattern reveals his posture and gesture merged along the body's axis done with greatest energetic involvement. This figure is an example of both baseline at its peak for this leader and an example of what in his body is his peak performance.

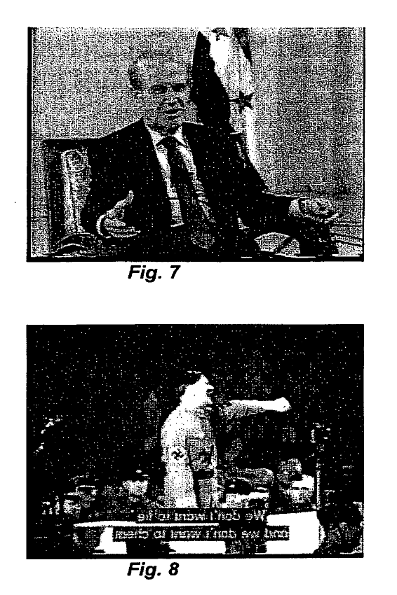

FIG. 7, an image of the late Syrian President Hafez Assad, reveals how the body can pattern into splitting between sides. In FIG. 7, it is as though one side of his self is expressing an idea (Middle East Peace process) seen in the gesture whereas the other side, showing his hand fidgeting, is making a comment on the communication. This figure shows an example of a disunified expression. Each side of the body is doing something different; it is as though the late President Assad is speaking out of two sides of the mouth.

FIG. 8, an image of Adolph Hitler, reveals his quintessential body attitude expressed in a gesture that became his signature and that of the Nazi party. The “Heil Hitler” gesture, if examined closely, reveals that he performed it with an inward twisting of the arm beyond the typical range of motion. It is as though he was unconsciously turning against himself. This is how a pattern embedded in the body can isomorphically foreshadow behavior such as the taking of his own life. Also, this emblematic symbol of the man was to become iconic for the political movement that he led, and shows how the movement expression of a leader can become an aspect of national character.

The present invention also introduces to the non-movement analystnonverbal communication expert the nature of behavioral and movement analysis in order to sensitize them to the efficacy and rudimentary aspects of how this approach is useful in political military contexts, including understanding how movement patterns can help predict political decisions. As a by-product, aspects of the practitioner's individual leadership style are sensitized. By understanding the process and potential results in themselves, practitioners begin to assess basic aspects of communicative and decision-making style in leaders and others in order to recognize when more in-depth expert analysis is desirable and may produce results that can avert political and military debacles.

Initially, the theoretical basis of leadership assessment through traditional political science and political psychology modes is reviewed, the practitioner is shown how using movement analysis and other nonverbal communication approaches supplements in a new and different way our understanding of what and how in real-time, high stakes contexts a leader behaves and makes decisions.

The practitioner is then acquainted with the nature of observation and its application in expert analysis and in day to day interaction. The nature of patterned behavior and its reflection in movement is explained. Sites of communicative contact are discussed in theory and experienced through exercises. Examples shown on video and in pictures, and certain movement pattern are actually experienced through movement exercises in the classroom. Behavior here refers to movement expression that reflects cognitive and emotional processes as well as performance qualities and is understood to underpin all human action, including leaders decisions taken in regard to political and military contingencies. The concept of isomorphism (how the smallest level of movement pattern drives behavior and resonates into larger behaviors and ultimately effects political decisions) is explained.

The practitioner is sensitized to appropriateness of a leader as a candidate for behavioral analysis. Certain individuals may be more desirable than others because of the complexity and richness of their nonverbal expression however, the absence of these elements thereof is also informative about a leader's baseline. This process enables the practitioner to, in the simplest way, describe the communicative style of the subject and determine if more in-depth expert analysis is desired. As full expert analysis is a labor intensive effort, a practitioner must weigh and decide if expected time in office and power wielded of targeted subject warrants such a more in-depth expert analysis. For example, if the new President of Russia comes to power and is expected to serve at least one four year term, it is likely desirable to recommend a more in-depth analysis. Moreover, the nature of this work reveals even before the leader comes to power aspects of their style such as how it relates to time, power, focus on the external environment, and their ability to allow life's inner ongoingess to occur. Their cognitive complexity and emotional proclivity too may be hypothesized about. In short, a snap shot of identity can be quickly gleaned from this kind of assessment at the onset a leader's tenure. (For example, video footage established that Putin had a profound movement loss long before he was sworn into office. Movement theory presumes a correlation with his behavior and decision-making style.

As a means by which to make this determination, a motivated practitioner is then guided to what materials are needed to begin the analytic process. Material such as videotapes of interviews, speeches and other interactions where the subject is engaged in serious communication such as questions and answers, an address to political body, in a tête-à-tête with another leader, in a meeting with top aides, in an informal occasion with family and friends may be used. A variety of venues are sought. However, it is typically necessary to have one serious extended display, such as a speech or interview where the subject is interviewed over several questions and answers to contrast their responses or be on tape speaking in a speech for at least fifteen minutes. The practitioner learns that the more complete the shot of the body, the better for analysis as more of the leader is revealed in motion.

The practitioner is exposed to the nature of macro and micro analytic approaches and shown how each approach relates to certain subsystems of the body as well as how basically the movement expert analyst will assess how all the communicative systems work together in a wholeness. Included in these approaches are Laban Movement Analysis, Lamb Movement Patterning Analysis, Lowen Bioenergetic Analysis, David McNeill gesticulation and multimodal analysis, Martha Davis' Movement Signature Analysis, States Analysis, Psychodiagnostic Inventory, Davis Connors Defensive Demeanor Profile, Erick Hawkins Philosophy and Performance Theory, Edward Hall Proxemics Method, Ekman & Freisen Facial Action Coding System, Bonnie Cohen neurodevelopmental patterning analysis, The Rosen Method, ethological/anthropological (Lorenz, Eibelsfeldt) and interaction (Chapple, Scheflen and Kendon) theories, and the field of deception/literature/research.

The practitioner is encouraged to consider which leader to study based on the value of having a behavioral portrait that can inform how best to relate to their decision-making style in regard to planning policy and military contingencies. The practitioner is encouraged to at the outset ask, in terms of framing the inquiry, what questions behaviorally about a leader's decision-making style can best inform policymakers in regard to imminent political military contingencies.

After a leader is chosen, research is done to ascertain if visual material is available that reveals their movement and communicative style. Once visual material is located, the practitioner reviews the material to determine if it meets criteria of length, viability of shot, and the presence of serious substantive and communicative exchange/interaction. During this phase transcripts of material is sought for correlation at a later stage.

The practitioner makes copy of material (e.g., video on videocassette, CD-ROM, or DVD); however video is often more user friendly and preferred for certain aspects of subtle analysis. Then the simple non-expert stage of analysis begins. (It may be desirable to preserve original footage for later use in a presentation.)

During this simple, non-expert stage of analysis, the practitioner turns off the sound and begins watching several times for wholeness of expression and your personal experience of being in the material and with the subject. After completing several viewings continue for about a couple more scans during which three primary tasks can be completed:

a. determination of length in time of material, e.g., a 13 minute interview)

b. determination of turn-taking, that is when a leader/subject is on camera and speaks and when an interviewer or other interactant is involved or speaks (if appropriate in the interview, for example) and,

c. determination of what aspects/systems of body signals are most expressive. This includes postural attitude, gesture, head, head and gaze, positions, facial expression, stress, dynamic qualities of time, force (power), focus in space and flow; energetic feeling, and, the overall level of involvement of these systems in relation to the whole. This is the simplest baseline.

The practitioner next prepares a longitudinal sheet that denotes the beginning and end of material in terms of minutes, for example with demarcations every ten seconds on the bottom of the sheet. The points where the subject is on tape versus where the interviewer appears are also denoted, for example by a personal hatch mark, and each system can be denoted by a separate coloration marking indicating when the leader is on tape expressing that behavior.

After review and determination of what systems are most relied upon and revealed by the subject, those systems are denoted. For example on the left side of the longitudinal chart the subsystems most communicatively relied upon that are to be assessed throughout the duration of the visual material being examined may be vertically shown.

Each system is singularly assessed from start to finish of the time scale and denoted, for example by hatch marks made on the longitudinal line. A yet different colored pencil may be used for each behavior to further differentiate the codes. This process heightens the practitioner/observers perception and offers insight into who they are observing and what the leader relies upon in their communicative systems to express themselves.

Once all systems have been assessed, the practitioner looks at the entire recording and determines what and if any patterns have emerged. That examination reveals where a behavior such as stress may have greatest recurrence and intensity. The chart can indicate, for example, where certain behavior may coalesce, where the subject's exhibits marked signs of stress or lack thereof, and where pure conviction may lie within the discourse. Upon completion of this process, a narrative for what the pattern reveals can be simply written.

The sound is then turned on and where patterns, in terms of turn-taking during an interview, are reviewed, and the topics (questions and answers) are then denoted on the longitudinal screen, for example at the top. Alternatively (or even additionally), one can note the location in a speech (or a protracted response) where certain topics are introduced and ended. The practitioner/regional expert can also assess in terms of importance at this stage which questions/topics they believe (for example, on a scale of one to five) might create for the leader the most stress or conversely, create the greatest ease. This review adds an objectifying check on how the behavior also relates to what is substantively being said.

This entire longitudinal graph can be informative on face value to the practitioner in that they have begun to see the nature of the leader's basic expression including cognition (gesture) and emotion (facial expression) and how it all fits together in performance (body attitude, posture, force, time focus, flow and stress) in relation to topic. In many cases, this initial analysis will suffice for the practitioner's level of inquiry. If behavioral patterns are unique and compelling, especially when correlated in relation to topic, a further step can be taken.

The practitioner can describe the finding and provide the graph to a movement analyst/nonverbal communication expert in the art, who can then begin a more in-depth full analysis of the subject focusing on the areas that nonverbally speak most loudly. Ideally, the practitioner can remain involved in the process in terms of locating materials that best display subject in relation to topic and primary behaviors.

Moreover, the practitioner can best brief other policymakers as to what is happening and in view of more in-depth understanding of the interaction of the leader's behavior and begin to fold that enhanced understanding into interpretation of leader's actions and into planning in terms of policy options and anticipating the subject's patterns, for example in regard to for example a military contingency. Finally, the practitioner may take this knowledge into the room when they meet or negotiate with a leader.

In the course of the process when the practitioner begins working with a movement nonverbal communication expert, the isomorphic element of how the movement can reflect what is happening in external context can be brought to the fore and predictions in terms of future political behavior as reflected through the pattern may emerge. Movement expression due to the consistency of pattern also reveals immediately (and can reflect change over time) elements of medical (neurological, physical, substance dependencies) disorganization, levels of certitude, conflict, and patterns of interaction between subject in a more refined way. The practitioner is thus brought into the process in a way that is both informative to them behaviorally as well as politically and enriches the in-depth movement expert's analysis.

Obviously, many modifications and variations of the present invention are possible in light of the above teachings. It is therefore to be understood that, within the scope of the appended claims, the invention may be practiced otherwise than as specifically described.

What is claimed is:

1. A method of assessing and predicting the behavior and decision making style of a person, comprising the steps of:
obtaining audiovisual source material in which said person is visible, speaking, and audible;
examining said source material without audio to establish a baseline pattern;
correlating said baseline pattern with said context and said audio so as to decode said person's emotional, cognitive and performance processes and establish a correspondence between specific signature movements and specific emotional, cognitive and performance processes of said person, thereby defining behavioral patterns;
reviewing additional source material in which said person is visible to determine recurrence of said behavioral patterns and determine recurring expressions for said person, said recurring expressions having a known relationship to said person's emotional and cognitive state,
correlating said stock expressions with said person's approach to taking action.

2. The method of claim 1, wherein said person is a political leader.

3. The method of claim 1, wherein said audiovisual source material has a known context and a known relationship between said context and said speaker, and wherein said correlating step further comprises correlating said baseline pattern with said context.

4. The method of claim 3, wherein said additional source material has a known context and a known relationship between said context and said speaker.
